(19) United States
(12) Patent Application Publication
(10) Pub. No.: US 2009/0326978 A1
(43) Pub. Date: Dec. 31, 2009

(54) Emergency Preparations for an Epidemic

(76) Inventors: Timothy J. Fultz, Pleasant Hill, CA (US); Gregory T. Went, Mill Valley, CA (US); Jack Nguyen, San Francisco, CA (US); Paul Spence, Novato, CA (US); David Chernoff, San Anselmo, CA (US); Terry L. Burkoth, Palo Alto, CA (US); Rowan Chapman, Burlingame, CA (US); Mickey S. Urdea, Alamo, CA (US)

Correspondence Address: Adamas Pharmaceuticals, Inc., 1900 Powell Street, Suite 1050, Emeryville, CA, 94608, US

(21) Appl. No.: 12/495,793

(22) Filed: Jun. 30, 2009

Related U.S. Application Data
(60) Provisional application No. 61/077,152, filed on Jun. 30, 2008.
(60) Provisional application No. 61/097,188, filed on Sep. 15, 2008.
(60) Provisional application No. 61/118,588, filed on Nov. 28, 2008.

(51) Int. Cl. G06Q 50/00; G06Q 90/00; G06Q 10/00

(52) U.S. Cl. 705/2; 705/500

(57) ABSTRACT

Stockpiles and methods of stockpiling a combination antiviral therapy for responding to an epidemic viral outbreak are described. Methods and systems of inventory control for co-deployment of drugs used in combination during a pandemic are described.

### TECHNICAL FIELD

The present invention relates to a method of stockpiling a combination antiviral therapy for responding to an epidemic viral outbreak. The invention also relates to systems and methods for drug co-deployment. More specifically, aspects of the present invention relate to systems and methods for providing a combination of drugs to the public for prophylaxis or treatment in the case of pandemic.

### BACKGROUND ART

The threat of a pandemic influenza outbreak is one for which local, state, and federal governments (as well as the private sector) are unprepared. There have been efforts to create stockpiles such as the US Strategic National Stockpile (SNS) for certain medicines and supplies, but the effort has been focused more on vaccines and oral medicines, particularly oral monotherapy in the case of influenza treatment and prophylaxis. Influenza treatments, however, have largely been ineffective, especially if initiated more than a day or two after infection. In a pandemic situation, very large numbers of infected individuals become infected in a very short period of time. Medical resources are likely to be overwhelmed and exhausted rapidly. Hospitals are unlikely to have sufficient materials on hand. In fact, having sufficient product on hand at all hospitals may not be practical or even feasible. Furthermore, the influenza treatments approved today, either a neuraminidase inhibitor such as oseltamivir or zanamivir or an M2 inhibitor such as amantadine or rimantadine, have led to the generation of drug resistant virus through mutation, typically through selective pressure.

In cases of pandemic such as, for example, a pandemic of influenza, coordinating supplies of drugs and materials in preparation for a pandemic or in response to an existing pandemic or other emergency situation presents a large problem in need of creative solutions. In the example of a pandemic influenza, large stockpiles of drugs for the treatment and prophylaxis already exist, and have been implemented at the cost of billions of dollars. However, problems related to the effectiveness of drugs that have been stockpiled, as well as efficient access to those drugs, currently exist.

It is an objective of this invention to provide novel solutions of stockpiling and rapid deployment of multiple medicines for treatment and/or prophylaxis of large numbers of individuals during an epidemic viral outbreak, particularly during pandemic influenza.

### DISCLOSURE OF THE INVENTION

### Methods of Stockpiling

In a first aspect, the invention provides a method of stockpiling a combination antiviral therapy for responding to an epidemic (including pandemic) viral outbreak. Examples of viral infections that pose potential epidemic/pandemic risks, and for which the invention can be used, include influenza and Severe Acute Respiratory Syndrome (SARS). The stockpiling may be pursuant to an emergency preparedness program—a rapid deployment program providing guidance or instructions for a government agency or a business or other organization in preparation for or response to an emergency situation such as an epidemic, a pandemic, catastrophic event, or act of war (such as a terrorist attack).

The invention provides a method of stockpiling a combination antiviral therapy for responding to an epidemic viral outbreak comprising:
a) procuring a plurality of therapeutic doses of a first antiviral agent having a first mechanism of action;
b) procuring a plurality of therapeutic doses of a second antiviral agent having a second mechanism of action; and
c) coordinating storage of the plurality of therapeutic doses of the first and second antiviral agents to enable shipment of the plurality of therapeutic doses of the first antiviral agent and shipment of the plurality of therapeutic doses of the second antiviral agent within 48 hours of each other.

In one embodiment, the method further comprises procuring a plurality of therapeutic doses of a third antiviral agent having a third mechanism of action and coordinating storage of the plurality of therapeutic doses of the first, second and third antiviral agents to enable shipment of the plurality of therapeutic doses of the first antiviral agent, shipment of the plurality of therapeutic doses of the second antiviral agent, and shipment of the plurality of therapeutic doses of the third antiviral agent within 48 hours of each other.

The invention further provides a method of procuring a plurality of therapeutic doses of a first antiviral agent having a first mechanism of action for use in a stockpile of the invention comprising:
a) procuring a plurality of doses of a first antiviral agent having a first mechanism of action; and
b) coordinating storage of the plurality of therapeutic doses of the first antiviral agent with a plurality of therapeutic doses of a second antiviral agent having a second mechanism of action to enable shipment of the plurality of therapeutic doses of the first antiviral agent and shipment of the plurality of therapeutic doses of the second antiviral agent within 48 hours of each other.

In one embodiment, the method comprises coordinating storage of the plurality of therapeutic doses of the first antiviral agent with a plurality of therapeutic doses of a second antiviral agent having a second mechanism of action and a plurality of therapeutic doses of a third antiviral agent having a third mechanism of action to enable shipment of the plurality of therapeutic doses of the first antiviral agent, shipment of the plurality of therapeutic doses of the second antiviral agent and shipment of the plurality of therapeutic doses of the third antiviral agent within 48 hours of each other.

In certain embodiments, the methods of the invention comprise coordinating storage of the plurality of therapeutic doses of the first, second and, optionally, third antiviral agents to enable shipment of the plurality of therapeutic doses of the first antiviral agent, shipment of the plurality of therapeutic doses of the second antiviral agent and, optionally, shipment of the plurality of therapeutic doses of the third antiviral agent within 24 hours of each other, e.g. within 12 hours, 8 hours, 4 hours, 2 hours or 1 hour of each other. In one embodiment, the method comprises coordinating storage of the plurality of therapeutic doses of the first, second and, optionally, third antiviral agents to enable shipment of the plurality of therapeutic doses of the first antiviral agent, shipment of the plurality of therapeutic doses of the second antiviral agent and, optionally, shipment of the plurality of therapeutic doses of the third antiviral agent substantially simultaneously.

Shipment of a plurality of therapeutic doses of antiviral agent means the step of the plurality of doses leaving the storage facility for deployment to a site of epidemic viral outbreak. Where shipment of the plurality of therapeutic doses of the first antiviral agent, shipment of the plurality of therapeutic doses of the second antiviral agent and, optionally, shipment of the plurality of therapeutic doses of the third antiviral agent within 24 hours of each other

The invention further provides a method of stockpiling a combination antiviral therapy for responding to an epidemic viral outbreak comprising:
a) procuring a plurality of therapeutic doses of a first antiviral agent having a first mechanism of action;
b) procuring a plurality of therapeutic doses of a second antiviral agent having a second mechanism of action; and
c) coordinating storage of the therapeutic doses of the first and second antiviral agents to enable within 48 hours either shipment or co-deployment to a site of epidemic viral outbreak in amounts sufficient to treat at least 100 patients with the combination antiviral therapy.

In one embodiment, the method comprises procuring a plurality of therapeutic doses of a third antiviral agent having a third mechanism of action and coordinating storage of the therapeutic doses of the first, second and third antiviral agents to enable within 48 hours shipment or co-deployment to a site of epidemic viral outbreak in amounts sufficient to treat at least 100 patients with the combination antiviral therapy.

The invention also provides a method of procuring a plurality of therapeutic doses of a first antiviral agent having a first mechanism of action for use in a stockpile of the invention comprising:
a) procuring a plurality of doses of a first antiviral agent having a first mechanism of action; and
b) coordinating storage of the therapeutic doses of the first antiviral agent with a plurality of therapeutic doses of a second antiviral agent having a second mechanism of action to enable co-deployment within 48 hours to a site of epidemic viral outbreak in amounts sufficient to treat at least 100 patients with the combination antiviral therapy.

In one embodiment, the method comprises coordinating storage of the therapeutic doses of the first antiviral agent with a plurality of therapeutic doses of a second antiviral agent having a second mechanism of action and a plurality of therapeutic doses of a third antiviral agent having a third mechanism of action to enable within 48 hours shipment or co-deployment to a site of epidemic viral outbreak in amounts sufficient to treat at least 100 patients with the combination antiviral therapy.

The invention also provides a stockpile of a combination antiviral therapy for responding to an epidemic influenza outbreak comprising:
a) a plurality of doses of a first antiviral agent having a first mechanism of action; and
b) a plurality of doses of a second antiviral agent having a second mechanism of action,

wherein the stockpile is stored to enable rapid deployment of the combination antiviral therapy in amounts sufficient to treat at least 100 patients.

In one embodiment, the above stockpile further comprises:
c) a plurality of doses of a third antiviral agent having a third mechanism of action preferable in an amount sufficient to treat at least 100 patients.

A combination antiviral therapy is one in which two or more antiviral agents are co-administered for treatment and/or prophylaxis of the viral infection. Preferably the two antiviral agents of the therapy have two different mechanisms of actions. In a particularly preferred embodiment, the combination antiviral therapy includes a third antiviral agent having a third mechanism of action, i.e. a mechanism of action that is different from that of the first and second antiviral agents. U.S. application Ser. No. 12/040,856 and WO2008/112775, incorporated herein by reference, describe various combination antiviral therapies for treatment or prophylaxis of influenza in which each antiviral agent of the combination therapy works by a different mechanism of action resulting in additive or synergistic effect.

In the stockpiling method of the invention a first plurality of doses of the first agent are procured, and a second plurality of doses of the second antiviral agent are procured. Preferably, the first and second pluralities are matched so that the stockpile includes an amount of the first antiviral agent to treat X number of patients, and an amount of the second antiviral agent to treat 0.80(X) to 1.20(X), preferably 0.90(X) to 1.10(X), and more preferably 0.95(X) to 1.05(X). For example, if the first plurality contains a number of doses for treating 100,000 patients for 15 days, the second plurality most preferably contain a number of doses for treating 95,000-105,000 patients for 15 days.

The doses may be “therapeutic” meaning that they are intended to treat patients with an established viral infection, or they may be “prophylactic” meaning that they are intended to be administered to patients who are not yet presenting with symptoms of the viral infection, but who may have already been exposed to the virus (e.g. family members or coworkers of a patient who has symptoms of the virus) or are likely to become exposed to the virus (e.g. healthcare workers responsible for treating infected patients). Unless indicated otherwise, “treating” a patient can be either therapeutic or prophylactic. Similarly, unless indicated otherwise, a “dose” can be either a therapeutic or prophylactic dose. In some cases, the dosage form of the therapeutic dose is identical to the prophylactic dose, the only difference being the daily amount administered to the patient. For example, the recommended dose of oseltamivir for prophylaxis of influenza is one 75 mg capsule per day. The therapeutic dose of oseltamivir is two 75 mg capsules/day. In other cases, the therapeutic and prophylactic doses of a given antiviral agent will be in different forms. For example, U.S. application Ser. No. 12/040,856 and WO2008/112775 describe triple combination antiviral therapies where each of the antiviral agents of the combination is formulated for parental administration for treatment of patients presenting with symptoms of influenza infection. For prophylaxis, the antiviral agents of the combination may be formulated for oral administration (e.g. oseltamivir, ribavirin and amantadine) or for inhalation (e.g. zanamvir). References herein to specific antiviral agents (e.g. amantadine, oseltamivir, etc.) are intended to include pharmaceutically acceptable salts of the antiviral agents (e.g. amantadine hydrochloride, oseltamivir phosphate, etc.). In one embodiment of the invention, both therapeutic and prophylactic doses of each of the antiviral agents of the combination therapy are procured and their storage coordinated for rapid co-deployment of combination antiviral therapy for both treatment and prophylaxis. For example, parenteral forms of each of amantadine, zanamivir and ribavirin may be stored and co-deployed with oral forms of the same drugs to provide treatment of patients with active influenza infection and to provide prophylaxis for the patients' caregivers or family members. In this embodiment, the quantity of dosage forms provided for treatment is likely to be different, preferably less than the number of dosage forms provided for prophylaxis, i.e. the number of individuals receiving prophylaxis from the stockpile are anticipated to be 3, 10, 30, 100 or more for each individual receiving therapeutic treatment. Where one or more of the antiviral agents of the combination therapy is for parenteral administration, the stockpiling method may further comprise procuring a plurality of a devices for parenteral administration of the antiviral agent(s), and coordinating storage of the devices to enable rapid co-deployment of the devices with the first and second antiviral agents. The devices may be selected from the group consisting of infusion bags, tubing, needles, heparin locks, metering devices, metering pumps, and combinations thereof.

In one embodiment, storage of the doses of the first and second, and if present third, antiviral agents is coordinated to enable their rapid shipment or co-deployment to a site of epidemic viral outbreak in amounts sufficient to treat at least 100 patients, and preferably at least 1,000, 10,000, 100,000, or 1,000,000 patients. In one embodiment, a “plurality” of therapeutic doses of an antiviral agent means at least 100 doses, preferably at least 1,000, 10,000, 100,000 or 1,000,000 doses.

During an epidemic viral outbreak, it should take less than 48 hours from the time the stockpiling coordinator is instructed to release a quantity of the stockpile to the time the delivery of the quantity is received at the site of use. Preferably the time from instructions to delivery receipt is less than 36, 24, 18, 12, or 6 hours. The antiviral agents may be stored in different facilities, provided plans are in place for coordinated receipt of the different agents at the same site of use or local disbursement in less than 8 hours from each other, and preferably in less than 6 or 4 hours. More preferably, the first and second antiviral agents are stored in the same facility, preferably together on shipping palettes or in shipping crates, boxes or carts for co-deployment. In a specific embodiment, at least a portion of the treatments of the first and second antiviral agents are stored within a single shipping container. For example, if the combination antiviral therapy is being deployed to treat 1,000 patients, a single shipping container may contain an amount of the first and second antiviral agents sufficient to treat 250 patients, with 4 such containers being sent to the site of use.

If one of the antiviral agents requires cold storage and the other antiviral agent(s) can be stored at room temperature, then it may be feasible to have only the room temperature-stored components stored in a shipment-ready manner with the cold-storage components stored nearby to minimize the time required to complete all parts of the shipment for deployment. In some embodiments, the first and second antiviral agents will be stored at a first facility, and a third antiviral agent will be stored at a different facility, again with their delivery being coordinated for receipt at the site of use within 8, 6, or 4 hours of each other.

In some embodiments, an “alternate antiviral agent” is stored as part of the stockpile which has the same mechanism of action as the first, second, or third (if present) antiviral agent, but has a different resistance profile. For example, oseltamivir and zanamivir are anti-influenza drugs that are both neuraminidase inhibitors. However, strains of oseltamivir-resistant influenza that retain sensitivity to zanamivir have been reported. Thus, a stockpile for influenza may comprise a plurality of doses of each of ribavirin, amantadine, oseltamivir, and zanamivir. If there is a high prevalence of oseltamivir-resistant influenza circulating during an epidemic, then the zanamivir could be co-deployed with the ribavirin and amantadine instead of the oseltamivir. There may be alternate antiviral agents for two or more of the antiviral agents. For example, there may be stored two drugs that act by a first mechanism of action, two drugs that act by a second mechanism of action, and optionally two drugs that act by a third mechanism of action, but only one drug of each of the two or three mechanism is deployed based on the strain of virus that is in circulation during the epidemic.

In one embodiment, there is provided a method of stockpiling a plurality of doses of an M2 inhibitor, an antiviral nucleoside analogue and, optionally, a neuraminidase inhibitor, comprising coordinating a selection of a plurality of doses of an M2 inhibitor, an antiviral nucleoside analogue and, optionally, a neuraminidase inhibitor in an emergency preparedness program for pandemic influenza, and storing the plurality of doses pursuant to the emergency preparedness program.

In this embodiment a plurality of doses of an M2 inhibitor (e.g. amantadine or rimantadine), an antiviral nucleoside analogue (e.g. ribavirin or viramidine), and optionally, a neuraminidase inhibitor (e.g. oseltamivir, zanamivir, or peramivir), are stockpiled, typically as part of an emergency preparedness program, i.e. a rapid deployment program providing guidance or instructions for a government agency or a business or other organization in preparation for or response to an emergency situation such as a pandemic, catastrophic event, or act of war (such as a terrorist attack).

For example, the antiviral agents may be stored on a shipping palette or in a shipping crate, box or cart. In response to an influenza pandemic, the stockpiled doses are deployed, optionally with instructions for co-administration of the M2 inhibitor, the antiviral nucleoside analogue, and optional neuraminidase inhibitor for prophylaxis or treatment of influenza. Both therapeutic and prophylactic doses of each of the antiviral agents of the combination therapy can be procured and their storage coordinated for rapid co-deployment and use in triple combination antiviral drug therapy. For example, parenteral forms of each of amantadine, zanamivir and ribavirin may be stored and co-deployed with oral forms of amantadine, ribavirin and oseltamivir. Patients with active influenza infection are treated with the parenterally administered drugs and the patients' caregivers or family members are treated with the orally administered drugs.

Kits that have one or more antiviral agent in a form for parenteral administration may further comprise devices for parenteral administration of the antiviral agent(s). In a stockpile, storage of the devices may be coordinated so that they can be rapidly co-deployed with the antiviral agents. The devices may be selected from the group consisting of infusion bags, tubing, needles, heparin locks, metering devices, metering pumps, and combinations thereof.

If one of the antiviral agents of a stockpiled kit requires cold storage and the other antiviral agent(s) can be stored at room temperature, the kit may comprise the room temperature-stored components stored in a shipment-ready manner with the cold-storage components stored nearby to minimize the time required to complete all parts of the shipment for deployment. In some embodiments, the first and second antiviral agents will be stored at a first facility, and a third antiviral agent will be stored at a different facility, with their delivery being coordinated for receipt at the site of use within 8, 6, or 4 hours of each other.

Exemplary kits for oral treatment are further detailed in Examples 1-4 below. Exemplary kits for parenteral administration are described in Example 5 below.

### Monitoring the Suitability of a Stockpile for Deployment

In a second aspect of the invention there is provided a method of monitoring the suitability of a stockpile of the invention for deployment in an epidemic comprising the steps of:
a) monitoring the suitability of the plurality of doses of the first antiviral agent for deployment in an epidemic;
b) monitoring the suitability of the plurality of doses of the second antiviral agent for deployment in an epidemic; and, if the results from steps a) and b) indicate that the plurality of doses of the first antiviral agent and the plurality doses of the second antiviral agent are suitable for deployment in an epidemic, then
c) approving the stockpile for deployment in an epidemic.

In one embodiment, if the results from steps a) and b) indicate that the plurality of doses of the first antiviral agent or the plurality doses of the second antiviral agent are not suitable for deployment in an epidemic, the method comprises the step of replacing the plurality of doses of the first or second antiviral agent which are not suitable for deployment in an epidemic with a plurality of doses of the same antiviral agent which are suitable for deployment in an epidemic.

Monitoring the suitability of the plurality of doses of antiviral for deployment in an epidemic, may typically involving testing one or more doses for efficacy or stability, or monitoring the expiration date of one or more doses (e.g. ensuring the doses are within the expiration date or within a defined period before the expiration date, for example 6 months before the expiration date). The monitoring may be carried out on bulk antiviral agent prior to packaging or on one or more packaged doses of antiviral.

Advantageously, the method of monitoring of the invention allows the stockpile keeper to minimise wastage of antiviral doses, e.g. by coordinating the storage of doses of different antivirals (i.e. the first, second and, optionally, third antivirals) to have similar expiration dates. Furthermore, in a typical situation where doses of different antivirals have different shelf-lives, it allows the stockpile keeper to optimise the number of doses of individual antivirals to maintain the capability of deploying the combination therapy over time.

In one embodiment, the method involves the step b2) of monitoring the suitability of the plurality of doses of the third antiviral agent for deployment in an epidemic; and, if the results from steps a), b) and b2) indicate that the plurality of doses of the first antiviral agent, the plurality doses of the second antiviral agent and the plurality of doses of the third antiviral agent are suitable for deployment in an epidemic, then c) approving the stockpile for deployment in an epidemic. In one embodiment, if the results from steps a), b) and b2) indicate that the plurality of doses of the first antiviral agent, the plurality doses of the second antiviral agent or the plurality doses of the third antiviral agent are not suitable for deployment in an epidemic, the method comprises the step of replacing the plurality of doses of the first, second or third antiviral agent which are not suitable for deployment in an epidemic with a plurality of doses of the same antiviral agent which are suitable for deployment in an epidemic.

### Increasing Effectiveness of Stockpiled Drugs

Furthermore, in light of the above-described problems and unmet needs, in a third aspect of the invention there is provided systems and methods to increase effectiveness of the stockpiled drugs as well as other newer drugs. It should be noted that because a virus typically may have a natural rate of mutation that allows it to adapt to a given drug, a combination of various drugs can achieve a higher efficacy against the virus because it becomes that much harder for the virus to adapt to multiple drugs simultaneously. According to various aspects of the current invention, stockpiled drugs as well as new combinations of drugs may be co-deployed to be provided in single dosage forms, or deployed in a manner that encourages the administration of the several drugs concurrently by the public during or prior to a pandemic. The combination of the several drugs, ingested as a single dosage form by a person, increases the effectiveness against the virus. For example, amantadine used alone may be less efficient against a virus than amantadine combined with other drugs such as, for example, ribavirin and oseltamivir.

According to various aspects of the current invention, prior to or on co-deployment the combination antiviral therapy can be formulated in several ways. For example, the drugs can be co-formulated together in a single formulation. The result of such a co-formulation may be a tablet, capsule, or dosage form to be ingested by a person as a treatment or prophylaxis to a pandemic. Another form for co-deployment may be a kit or blister package including the several drugs to be ingested together by a person. The drugs may be enclosed in separate blister spaces within the kit. Alternatively, two or more of the drugs may be co-formulated and provided in, for example, a single tablet, capsule or other dosage form, to be ingested at the same time as, or as a single dosage with, other drugs that are not co-formulated to the co-formulated drugs, and that are also present in the same kit. According to various aspects of the current invention, the number of doses, specific dosage forms to be taken at each dosing, the frequency of dosing, or the period of time for which a person should take the drugs may also be specified.

In preparation for an epidemic, pandemic or other health emergency, supplies of all of the drugs for the combination therapy may be stockpiled for rapid deployment. The supplies may be stored as the raw materials (especially the active pharmaceutical ingredients) to prepare finished dosage forms, or as ready to use intermediates (such as pellets, granules or other formulation that could be readily filled into capsules, tableted, or packaged for bulk administration), or as tablets or capsules in bulk containers ready for primary packaging, or in primary packaging such as blister packs or bottles for distribution to individuals. If the supplies are in primary packaging, these packages may also be packaged into secondary packaging such as boxes and/or palleted such that deployment of large quantities of supplies may be accomplished efficiently. In some embodiments, a primary packaging unit comprises one or more of the first, second, or, optionally, third antiviral agent in sufficient quantities to treat at least 5 patients, preferably at least 10, 100 or 1,000 patients.

Preferably, the quantity to treat one patient is an amount of the drugs to treat the patient for an effective period of time. Typically this will be at least 5 days and in some instances at least 7 days or even at least 10 days.

In one embodiment, the primary packaging, second packaging, kit, device or composition of the invention may include instruction means for indicating the dosing regimen for patients receiving the combination antiviral treatment. Instruction means include written instruction means, e.g. instructions provided on paper, cardboard, plastic etc., or media device instructions means, e.g. instructions on a magnetic tape, optical disc, computer hardware means, flash memory, etc. The instructions can address therapeutic dosing, prophylactic dosing, or both.

In one embodiment, there is provided a computer program comprising computer-executable instructions, comprising:

first instructions for determining whether a facility in which a first drug is stored has a second drug present in the same facility or other location under common inventory control as the facility; and

second instructions for determining whether: (i) the second drug is not present in the facility or other location; or (ii) the second drug is not present in the facility or other location in a sufficient given quantity to support co-deployment of the first and second drugs.

A sufficient given quantity is defined as a quantity which can support co-deployment of the first and second drugs. It may be representative of a lower limit of a quantity of unit dosages of the second drug, e.g. at least 1, 2, 5, 10, 100, 1000, 10000, 1×10⁵, 1×10⁶, 1×10⁷, 1×10⁸, 2×10⁸, or of a lower limit a given volume of the second drug, e.g. sufficient quantities of bulk API or formulations (which may be used for tabletting or encapsulation) to prepare at least 1×10⁴, 1×10⁵, 1×10⁶, 1×10⁷, 1×10⁸, 1×10⁹ doses.

The computer program may further comprise third instructions for generating a request for obtaining the second drug when the second instructions make an affirmative determination.

In a second embodiment, there is provided a computer program product comprising the computer program.

In a third embodiment, there is provided a system for monitoring coordinated drug shipment or drug co-deployment, comprising:

memory for storing the computer program of the invention; and

a processor connected to the memory for executing the computer-executable instructions of the computer program

The system may further comprise:

an accessor in communication with the memory for supplying data relating to quantities of first and second drugs present in the facility.

The accessor is preferably a data acquisition device which automatically determines and monitors the quantities of first and second drugs in the facility, e.g. by reading data on packaging of the drugs as they arrive and depart the facility.

### Combination Antiviral Therapies

The combination antiviral therapies of the invention comprise first and second antiviral agents for the treatment and/or prophylaxis of the viral infection. Preferably the two antiviral agents of the therapy have two different mechanisms of actions. In a particularly preferred embodiment, the combination antiviral therapy includes a third antiviral agent having a third mechanism of action, i.e. a mechanism of action that is different from that of the first and second antiviral agents.

In one embodiment, the first antiviral agent and the second antiviral agent are an M2 inhibitor and an antiviral nucleoside analogue. In another embodiment, the first antiviral agent, the second antiviral agent and the third antiviral agent are an M2 inhibitor, an antiviral nucleoside analogue and a neuraminidase inhibitor.

M2 inhibitors include amantadine and rimantadine. Antiviral nucleoside analogues include ribavirin and viramidine. Neuraminidase inhibitors include oseltamivir, zanamivir and peramivir.

In one embodiment, the first antiviral agent and the second antiviral agent are amantadine and ribavirin. In one embodiment, the first antiviral agent, the second antiviral agent and the third antiviral agent are amantadine, ribavirin and a neuraminidase inhibitor (e.g. oseltamivir or zanamivir). In one embodiment, the first antiviral agent, the second antiviral agent and the third antiviral agent are amantadine, ribavirin and oseltamivir.

It should be noted that the “first”, “second” etc. antiviral agent may be any of the antiviral agents in the combination antiviral therapy.

U.S. application Ser. No. 12/040,856 and WO2008/112775, incorporated herein by reference, describe preferred antiviral therapies which may be stockpiled in the invention.

For example, WO2008/112775 discloses a composition for the treatment or prophylaxis of influenza in a patient, said composition comprising: 10-60 weight percent (wt. %), 25-50 wt or 50-75 wt % amantadine or rimantadine; and 30-80 wt. %, 50-75 wt. %, or 25-50 wt. % ribavirin or viramidine, wherein the weight percents are based on the total weight of active agents in the composition. In specific embodiments, the composition further comprises 0.5-30 wt. % oseltamivir.

In one embodiment, the composition is in a formulation suitable for oral or gastric administration, such as a liquid, syrup, suspension, tablet, capsule, beads in capsules, or beads in sachets. In a specific embodiment, the composition is in a unit dosage form for oral administration comprising 25-125 mg amantadine or rimantadine and 50-200 mg ribavirin or viramidine. In a specific embodiment, the unit dosage form comprises at least 125 mg amantadine in an extended release form, and less than 200 mg ribavirin. In another embodiment the unit dosage form comprises 25-125 mg amantadine and 50-200 mg ribavirin.

In another embodiment, the composition is in a form suitable for parenteral administration, such as a lyophilized powder, which is reconstituted prior to administration, or a sterile liquid in a vial.

WO2008/112775 also provides a kit for the treatment or prophylaxis of influenza in a patient comprising amantadine or rimantadine, and ribavirin or viramidine, and optionally a neuraminidase inhibitor such as oseltamivir, zanamivir, or peramivir.

In a specific embodiment, a kit is provided for the oral treatment or prophylaxis of influenza in a patient comprising a plurality of dosage forms, said plurality constituting one or more doses, each dose comprising a therapeutically or prophylactically effective amount of a combination of ribavirin and amantadine. The amantadine and ribavirin may be formulated as separate dosage forms or co-formulated as single dosage forms. The amantadine may be in an extended release form. In a specific embodiment, the amantadine and ribavirin are formulated as separate dosage forms, with each amantadine dosage form comprising 75-250 mg amantadine, and each ribavirin dosage form comprising 50-200 or 100-400 mg ribavirin. In various embodiments, the kit comprises an amantadine dosage form in a dosage strength selected from 80 mg, 180 mg, and 330 mg, and a ribavirin dosage form in a dosage strength selected from the group consisting of 115 mg, 330 mg and 660 mg. In one embodiment, each dose further comprises oseltamivir.

In another embodiment, the kit is provided for parenteral treatment of influenza in a human patient, comprising amantadine in a form suitable for parenteral administration; and ribavirin in a form suitable for parenteral administration. The amantadine may be contained in a plurality of first vials, and the ribavirin contained in a plurality of second vials. Alternatively, the amantadine and ribavirin are co-formulated and contained in a plurality of vials. The kit may further comprise oseltamivir, peramivir, or zanamivir in a form suitable for parenteral administration.

In a preferred embodiment the first and second antiviral agents are administered in amounts that increase sensitivity of an influenza virus to the third antiviral agent by at least 2-fold over sensitivity of the virus to the third antiviral agent when used as monotherapy. In a specific such embodiment, the first and second antiviral agents are ribavirin and oseltamivir, and the third antiviral agent is amantadine.

In a specific embodiment, the patient is administered amantadine or rimantadine in an amount to maintain a plasma concentration between 0.1 to 3.0 μg/ml, 0.1 to 1.5 μg/ml, or 0.3 to 1.5 μg/ml for at least 48 continuous hours.

In another embodiment, the patient is administered amantadine or rimantadine parenterally or orally in an amount of 5 to 500 mg/day, 20 to 250 mg/day, 100 to 800 mg/day, 100 to 600 mg/day, 200 to 700 mg/day, or 200 to 500 mg/day. When orally administered, amantadine is optionally in an extended release form.

In a further embodiment, the patient is administered amantadine by intravenous infusion at a rate of 1 to 50 mg/hr, 3 to 40 mg/hr, or 5 to 30 mg/hr for at least 48 continuous hours.

In one embodiment, the patient is administered ribavirin or viramidine in an amount to maintain a plasma concentration between 0.1 to 10.0 μg/ml, 0.5 to 8 μg/ml, 0.5 to 5.0 μg/ml, 1 to 6 μg/ml, 1 to 4 μg/ml, 2 to 6 μg/ml, 2 to 4 μg/ml, 0.01-2 μg/ml, or 0.2-2 μg/ml for at least 48 continuous hours.

The patient is administered ribavirin parenterally or orally in an amount of 50 to 2000 mg/day, 50 to 1600 mg/day, 100 to 1200 mg/day, 400 to 800 mg/day, 50 to 600 mg/day, 75 to 500 mg/day, or 75 to 200 mg/day.

In a specific embodiment, the patient is administered ribavirin by intravenous infusion at a rate of 5 to 200 mg/hr, 10 to 150 mg/hr, 15 to 100, or 20 to 80 mg/hr for at least 48 continuous hours.

In a specific embodiment, wherein the patient is administered amantadine or rimantadine in one of the above-specified amounts together with ribavirin or viramidine in one of the above-specified amounts, the patient is further administered a neuraminidase inhibitor selected from the group consisting of oseltamivir, oseltamivir carboxylate, zanamivir, and peramivir, in an amount to maintain a plasma concentration of the neuraminidase inhibitor between 0.001-5 μg/ml, 0.02 to 5 μg/ml, 0.1 to 3 μg/ml, 0.1 to 1 μg/ml, 0.3 to 3 μg/ml, or 0.3 to 1 μg/ml for at least 48 continuous hours.

In a specific embodiment, the patient is administered zanamivir by intravenous infusion at a rate of 0.1 to 10 mg/hr, 0.4 to 7 mg/hr, or 1 to 5 mg/hr for at least 48 continuous hours.

In another embodiment, the patient is administered oseltamivir by intravenous infusion at a rate of 0.1 to 20 mg/hr, 0.4 to 7 mg/hr, 1 to 7 mg/hr, 1 to 5 mg/hr, or 2 to 7 mg/hr for at least 48 continuous hours.

In various embodiments, the patient may be administered oseltamivir parenterally or orally in an amount of 10 to 150 mg/day, 10 to 50 mg/day, 50 to 100 mg/day, 75 to 150 mg/day, 150 to 300 mg/day, 100 to 500 mg/day, or 1 to 50 mg/day.

### BRIEF DESCRIPTION OF THE DRAWINGS

Various exemplary aspects of the systems and methods of the invention will be described in detail, with reference to the following figures, wherein:

FIG. 1 is an illustration of a co-deployment system, according to various exemplary aspects of the current invention;

FIG. 2 is an illustration of a co-deployment system, according to various exemplary aspects of the current invention;

FIG. 3 is an illustration of a co-deployment system, according to various exemplary aspects of the current invention;

FIG. 4 is a flow chart illustrating a co-deployment method, according to various exemplary aspects of the current invention;

FIG. 5 presents an exemplary system diagram of various hardware components and other features, for use in accordance with an aspect of the present invention; and

FIG. 6 is a block diagram of various exemplary system components, in accordance with an aspect of the present invention.

FIGS. 7A-11 are plan views of six different respective blister packs comprising dosage forms according to different embodiments of the present invention.

### MODES FOR CARRYING OUT THE INVENTION

### Systems and Methods for Increasing Effectiveness of Stockpiled Drugs

These and other features and advantages of this invention are described in, or are apparent from, the following detailed description of various exemplary aspects.

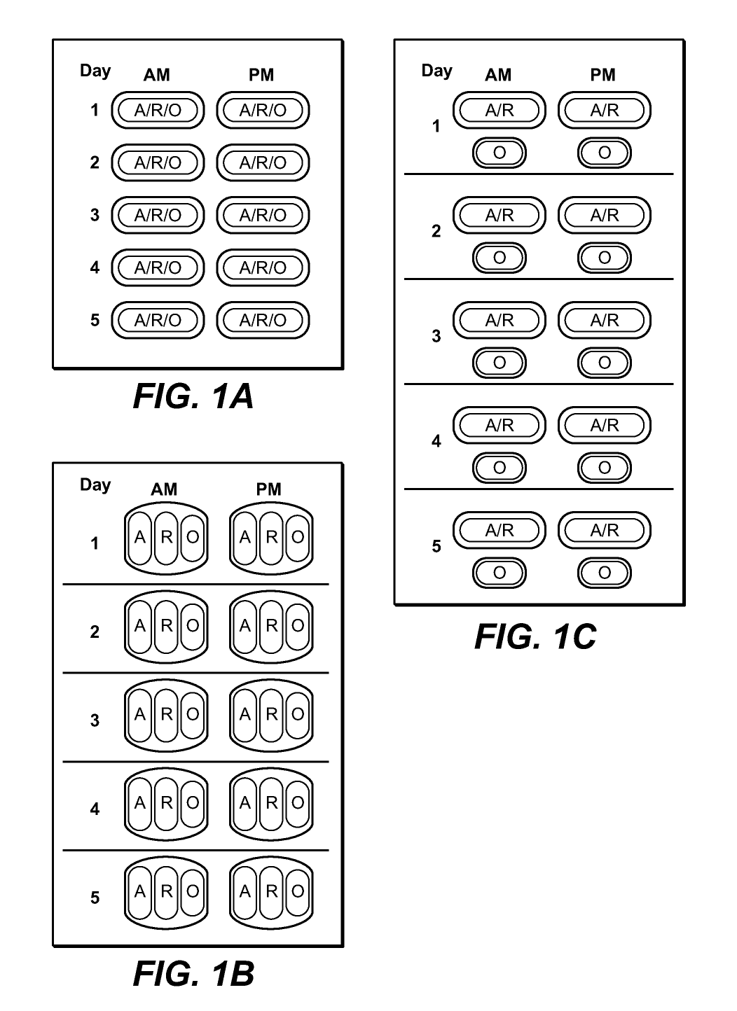

FIG. 1 is an illustration of a co-deployment system, according to various exemplary aspects of the current invention. In FIG. 1, three different drugs are being co-deployed within a kit or blister package for simultaneous ingestion by a person, the three drugs being referred to as A, R and O. In the case of a pandemic of influenza, the three drugs may be, for example, amantadine, ribavirin and oseltamivir, or any other combination of drugs that would be effective in preventing influenza. Alternatively, the three drugs may be rimantadine, viramidine and zanamivir, or other drug combinations disclosed in U.S. application Ser. No. 12/040,856 to Nguyen et al., incorporated herein by reference. The kit may be arranged to indicate clearly the drugs to be taken during, for example, the morning and/or the afternoon. The kit may also be arranged to indicate different times during the day when a person should ingest the drugs as a single dosage.

In FIG. 1A, the three drugs A, R and O are co-formulated as a single tablet or capsule in a single blister package A/R/O that can be ingested as a single dose by a person. Alternatively, a dose may comprise two tablets or capsules (not shown in FIG. 1A) that, to facilitate swallowing, are smaller than they would otherwise be when formulated as a single tablet or capsule. The kit may indicate the tablet or capsule to take in the morning, and/or the pill or dose to take in the afternoon, if necessary. In FIG. 1B, the three drugs are separate tablets or capsules disposed together within a same blister package in the kit so as to be ingested concurrently as a single dosage. For example, a person may ingest the three tablets or capsules at once, one dosage form each for A, R and O. The case illustrated in FIG. 1B may be the case where the drugs A, R and O are provided from various sources such as, for example, existing stockpiled supplies. In FIG. 1C, the kit is arranged to provide a co-formulation of drugs A and R in a single tablet or capsule in a separate blister package, and a tablet or capsule for drug O in a separate blister package. Thus, a person may ingest two dosage forms as a single dose or at the same time, one dosage form comprising a combination of A and R (or two smaller dosage forms each comprising a combination of A and R, not shown), and one separate dosage form comprising O. FIG. 1B or 1C may correspond to situations where one or more of the drugs, such as drug O in FIG. 1C, are already stockpiled in large quantities. In this case, instead of re-formulating new batches of drug O, the stockpiled O may be combined to drugs A and R in a single kit in order to avoid wasting the possibly large amounts of stockpiled O drug.

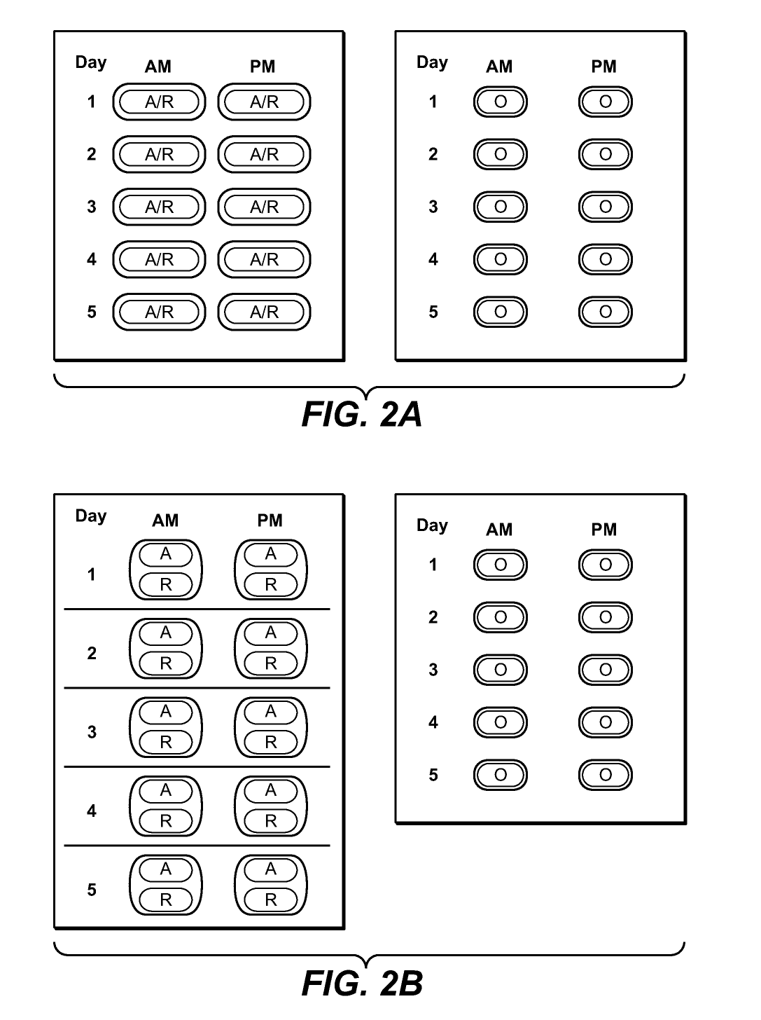

FIG. 2 is an illustration of a co-deployment system, according to various exemplary aspects of the current invention. In FIG. 2, three different drugs are being co-deployed two blister packages within a kit for ingestion by a single person as a single dosage, the three drugs being referred to as A, R and O. In the case of a pandemic of influenza, the three drugs may be, for example, amantadine, ribavirin and oseltamivir, or any other combination of drugs that would be effective in preventing influenza. Alternatively, the three drugs may be amantadine, ribavirin and zanamivir. The kit may be arranged to indicate the drugs to be taken during, for example, the morning and/or the afternoon. The kit may also be arranged to indicate different times during the day when a person should ingest the drugs.

In FIG. 2A, the two drugs A and R are co-formulated as a single dosage form that can be ingested as a single dose by a person and the dosage forms are arranged in a separate blister package, while the drug O, which may have been previously formulated and provided from existing supplies, is also arranged in a separate blister package. In FIG. 2A, the two dosage forms of A/R and O are to be ingested at the same time (as a single dose) by the person. The kit may also indicate the dose to take in the morning, and the dose to take in the afternoon. Thus, a person may be given a kit that is a combination of a blister package only containing O with a blister package containing co-formulated A and R. In FIG. 2B, the three drugs are also disposed together within the kit so as to be ingested as single dosage, however drugs A and R are provided as separate dosage forms in the same blister package. In this case, the drug O may be provided from existing supplies, arranged in a separate blister package, and added to a combination of the drugs A and R in the same kit. In FIG. 2B, the drugs A and R are formulated separately. Thus, a person may be given a kit that is a combination of a blister package containing only O with a blister package containing both A and R separately, and ingests all three drugs at the same time or as a single dosage.

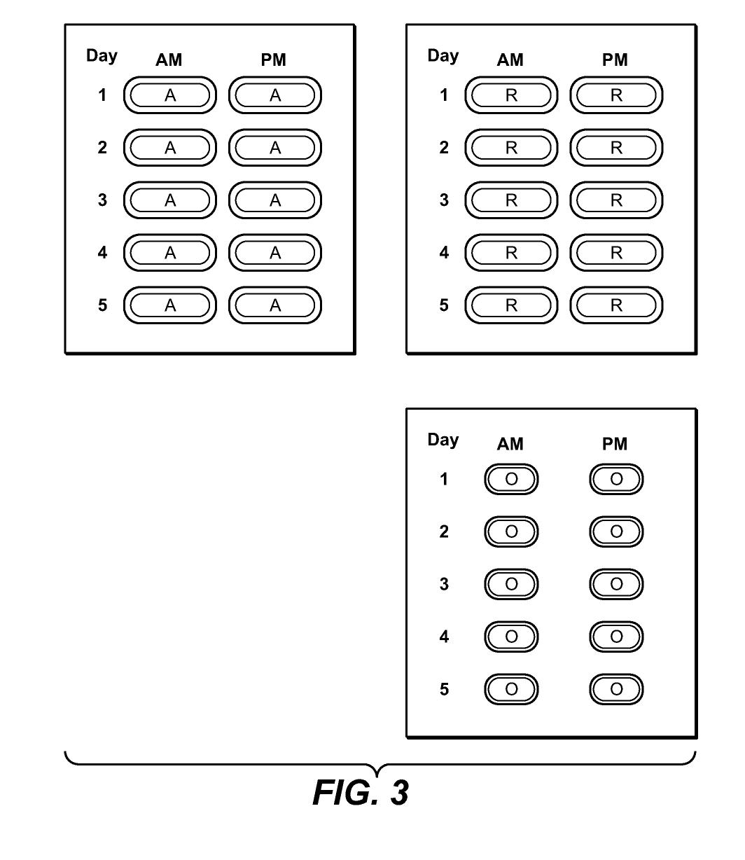

FIG. 3 is an illustration of a co-deployment system, according to various exemplary aspects of the current invention. In FIG. 3, the kit may be arranged to hold three separate blister packages, each including one of the three drugs A, R and O, so as to be removed separately from their respective blister packages before being ingested simultaneously or as a single dosage by a person. a person removes each dose of drug from its blister package and ingests them simultaneously or as a single dosage. In a preferred embodiment, the dosage forms for all of the drug products are arranged in a similar configuration to simplify the recognition of proper dosing by the person administering or receiving the drug products.

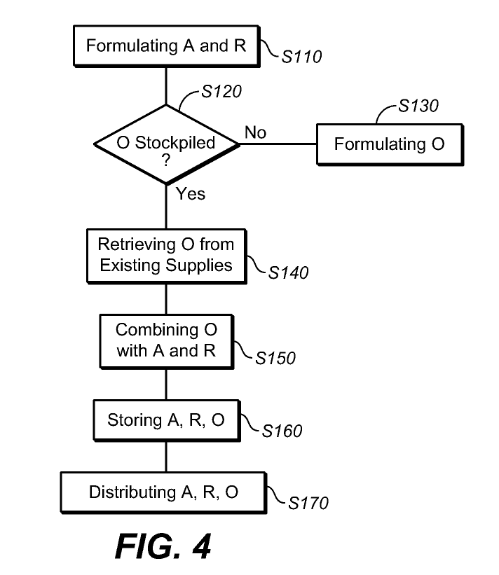

FIG. 4 is a flow chart illustrating a drug co-deployment method, according to various exemplary aspects of the current invention. In FIG. 4, the method starts at S110, where the drugs A and R are formulated. According to various aspects of the current invention, A and R may be co-formulated in single doses or pills, or may be formulated separately in separate doses or pills. If the drugs A and R are formulated separately in separate doses or pills, then a person may ingest both doses or pills as a single dosage of A and R. The method continues to S120, where a determination is made about whether the drug O is stockpiled in existing supplies, i.e. either in the same storage facility as the A and R, or in another location under common inventory control.

If the drug O is not stockpiled in existing supplies, then the method continues to S130, where the drug O is formulated. According to various aspects of the current invention, the drug O may be formulated separately from drugs A and R, in which case a kit containing all three drugs may contain a separate blister package containing a single dose or pill of drug O and a separate blister package containing a single dose or pill of a co-formulation of drugs A and R. Alternatively, the kit may contain a separate blister package for each of drugs O, A and R. The kit may also contain a single blister package containing one pill each of O, A and R. Alternatively, the drug O may be co-formulated together with either drug A, or with drug R, or with both drugs A and R in a single dose or pill. In either case, the kit may contain a separate compartment or blister package for each co-formulated dose, and a separate compartment or blister package for any separate or separately co-formulated drugs. The kit may also contain a single blister package containing a plurality of pills, co-formulated and non co-formulated drugs. According to various aspects of the current invention, regardless of how the various drugs are arranged within the kit, the kit contains all three drugs A, R and O that can be ingested as a single dosage by a person. The kit may also contain instructions on how many times a person should ingest the three drugs as a single dosage and/or for what period of time.

Alternatively, if during S120, there is a determination that the drug O is stockpiled in existing supplies, then the method continues to step S140, where the drug O is retrieved from existing supplies. The method then continues to S150, where the drug O is combined with drugs A and R in a kit. According to various aspects of the current invention, the drug O may be combined with drugs A and R wherein each one of O, A and R is in a separate blister package as a separate dose or pill, or all three drugs O, A, R are in the same blister package as three separate doses or pills. In this case, the kit may contain groups of three separate blister package, each group holding a separate dose of A, R and O. If the drug O is combined with a co-formulation of drugs A and R in the same blister package, then the kit may contain groups blister packages containing a dose of drug O and a dose of co-formulated drugs A/R. Alternatively, the drug O may be combined with a co-formulation of drugs A and R, where the O is in a separate blister package and co-formulated A/R is in a separate blister package within the same group. According to various aspects of the current invention, regardless of how the various drugs are arranged within the kit, the kit contains all three drugs A, R and O that can be ingested as a single dosage by a person. The kit may also contain instructions on how many times a person should ingest the three drugs as a single dosage and/or for what period of time.

In addition to deciding to create kits of, e.g., one or more separate fills due to some of the pills being available in existing supplies, the decision to combine separate pills in a kit may also be made for other reasons, such as different expiration dates of the various drugs to be included in the kit. In the case of varying expiration dates, it may be more efficient to package drugs with close expiration dates (e.g. a one year or less difference in expiration dates) in the same blister package, and to package the drugs that have varying expiration dates in a separate blister. Furthermore, if research is being conducted to determine the efficacy of a first drug that is stockpiled with one or more drugs when taken in combination with a second drug, it may be beneficial to store the first drug in a separate blister packages from the drugs it is being stockpiled with, in case it is later determined that it should rather be taken with the second drug.

According to various aspects of the current invention, once the three drugs A, R and O are combined in a manner that allows a person to ingest them as a single dosage, the method continues to S160, where the combined drug, which is a combination of the three drugs A, R and O in a single dosage, may be stored for the purpose of being combined to fight or to be a prophylaxis to a pandemic. A pandemic may be, for example, a pandemic of influenza. In this step, any stockpiles of any of A, R and/or O may be monitored to determine whether the drugs are still effective. For example, effectiveness may be measured by the fact that their expiration date has not been reached yet. Any stockpiles of A, R and O may also be monitored to determine whether they are physically able to be combined together and distributed in an adequate amount of time given the emergency of, for example, a pandemic. Monitoring stockpiles of A, R and O may also include a determination of whether there is an approximately equal amount of all three drugs to provide a large number of people with the possibility of ingesting all three drugs as a single dosage for a prescribed dosing regimen, whether or not the three drugs are stockpiled in the same location or in a different location, and/or whether updating the inventory regularly is necessary to maintain a stockpile of drugs that are still efficient. Stockpiles of A, R and O may be located in the same area, and may be located in different areas. For example, a same warehouse may include one or more of the three drugs, and several warehouses may include one or more of the three drugs. Preferably, the multiple drug products required for the treatment or prophylaxis are stored in close proximity to each other, e.g. the same warehouse, the same room, or most preferably the same shelf or adjacent to one another.

According to various aspects of the current invention, the method continues to S170, where the combined drug, which is a combination of the three drugs A, R and O in a single dosage, is distributed to the public for the purpose of being combined to treat infection or to be a prophylaxis to a pandemic. A pandemic may be, for example, a pandemic of influenza. For example, the three drugs may be distributed by retrieving them from various stockpile areas and pooling them in various distribution centers where they can be combined together before being distributed to the public.

According to various aspects of the current invention, in a case where only three drugs are used together as a combination as a prophylaxis or treatment of a pandemic situation or other emergency, all three drugs A, R and O, may be pulled from different stockpiles and combined together in packages to allow persons to ingest all three drugs as a single dosage for a number of times and/or over a period of time. Alternatively, other combinations of drugs may be used instead of A, R, and O, and also more than three drugs may be used as a combination to fight a health emergency or to provide prophylaxis to a health emergency. All these drugs may be pulled from existing supplies and combined as discussed above to allow a person to ingest all the drugs together in a single dosage, which provides an increased efficiency in fighting a spreading pandemic, or merely as a prophylaxis.

The above passages describe storage of dosage forms in ready to deploy packaging, which can minimize the time to deployment in an emergency situation and simplify the physical deployment. Alternatively, bulk storage of intermediates and raw materials can have distinct advantages as well. In one embodiment, the capsules or dosage forms may be stored in bulk packaging ready for dispensing according to the immediate need. If, for example, a determination is made that the appropriate combination therapy is rimantadine, ribavirin and oseltamivir instead of amantadine, ribavirin and oseltamivir, millions of bulk capsules or tablets of the desired combination may be packaged in blister packs or bottles within days for ready deployment. Bulk capsules or tablets will also require less warehouse space and cost for implementation than storage of pallets of blister packages of ready to deploy drug product.

In another embodiment, if the formulations are prepared and stored in bulk, they may be tableted or encapsulated as needed to prepare the dosage forms for packaging and distribution. Storing the bulk formulations provides a further reduction is stockpiling costs, while retaining the ability to prepare and deploy effective combinations for treatment or prophylaxis. Very high throughput equipment to prepare capsules or tablets is readily available which can provide in excess of 25,000, 50,000, 100,000, or 150,000 dosage forms per hour per machine.

In another embodiment, the raw materials of the combination therapy are stockpiled, specifically, two or more of the active pharmaceutical ingredients, preferably all of the active pharmaceutical ingredients. Optionally, one or more of the excipients is also stockpiled. This approach is particularly advantageous where the raw materials may be of limited production or where the supply chain may be restricted, especially because of an emergency such as a pandemic, act of war, or even a trade dispute if the raw material is sourced from a foreign entity. Ensuring that sufficient materials are readily available to meet surge requirements in a pandemic or to continue production while alternative sources are developed is important to the security of the health of the nation. In a preferred embodiment, sufficient stockpiles of raw materials are maintained in secured storage for each raw material determined to be at risk of supply shortage. A plan such as a national preparedness plan may describe the quantities and/or the identities of such materials to be stockpiled. The raw materials procured for such stockpiles are preferably stored in quantities sufficient to prepare a common quantity of the combination treatment. While the advantage of secure supply has been described, it will be readily appreciated that the cost of acquiring and stockpiling raw materials is lower than acquiring and storing finished drug products. Such raw materials are not a substitute for the rapidly deployable kits described within this specification, but these materials will be important to production of additional product for replenishment of the finished drug product in case of deployment or if substantial, additional product is required for deployment to meet surge demand needs.

According to various aspects of the current invention, the decision-making involved in the above-described method steps may be automated and implemented via various hardware and computer components.

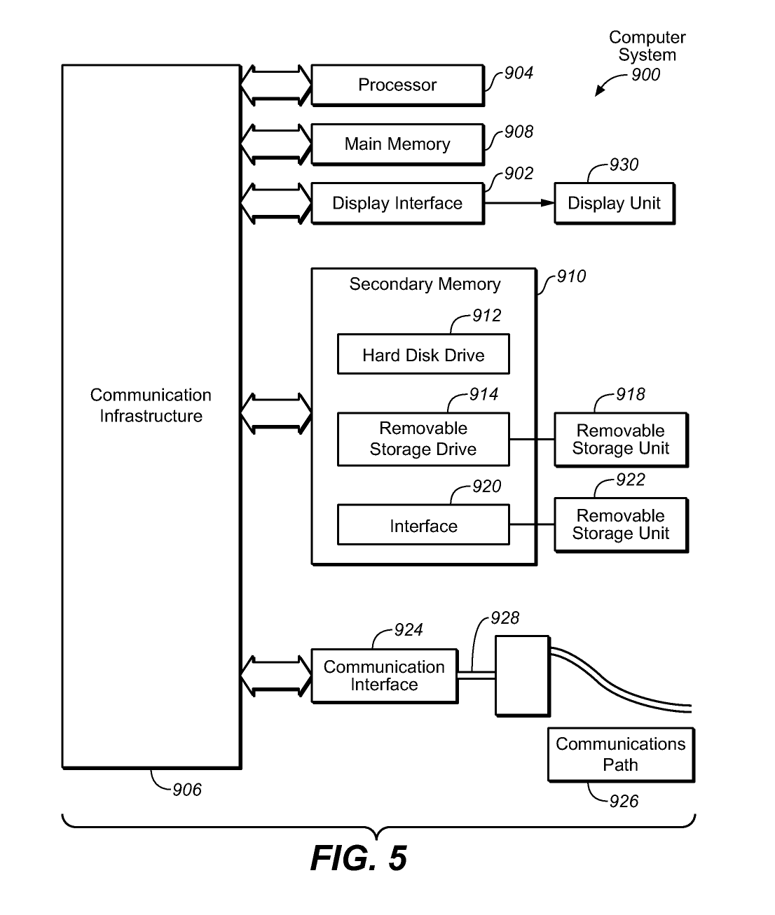

FIG. 5 presents an exemplary system diagram of various hardware components and other features, for use in accordance with an aspect of the present invention. The present invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 5.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software, in the form of a computer program, to the computer system 900. The invention is directed to such computer program products and computer programs.

The computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 904 to perform the features of the present invention. Accordingly, such computer programs represent controllers of the computer system 900.

In an aspect where the invention is implemented using software, the software may be stored as a computer program in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

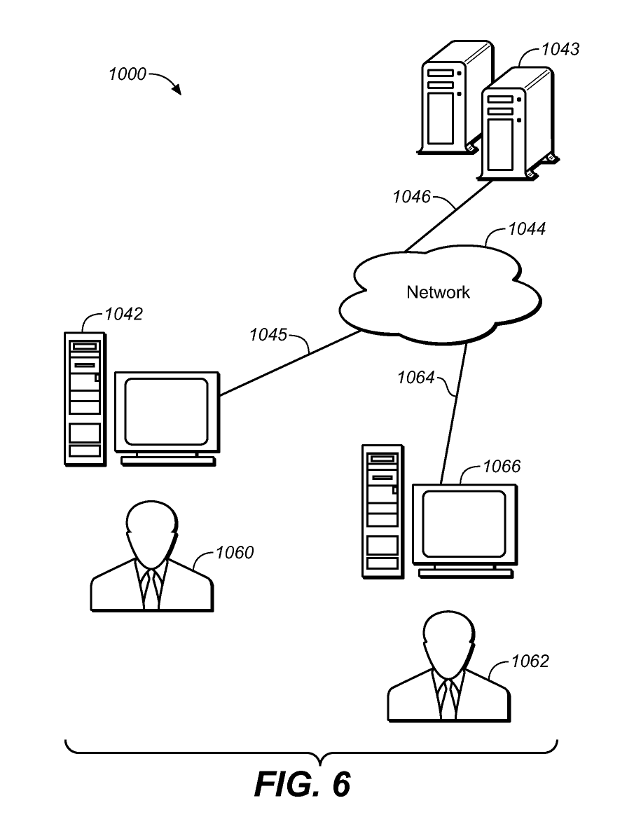

FIG. 6 is a block diagram of various exemplary system components, in accordance with an aspect of the present invention. FIG. 6 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another aspect, the method and system of the present invention operate in a stand-alone environment, such as on a single terminal.

### Kits for Use in Stockpiles

### EXAMPLE 1

### A Kit of Extended Release Amantadine Hydrochloride, Ribavirin and Oseltamivir Phosphate

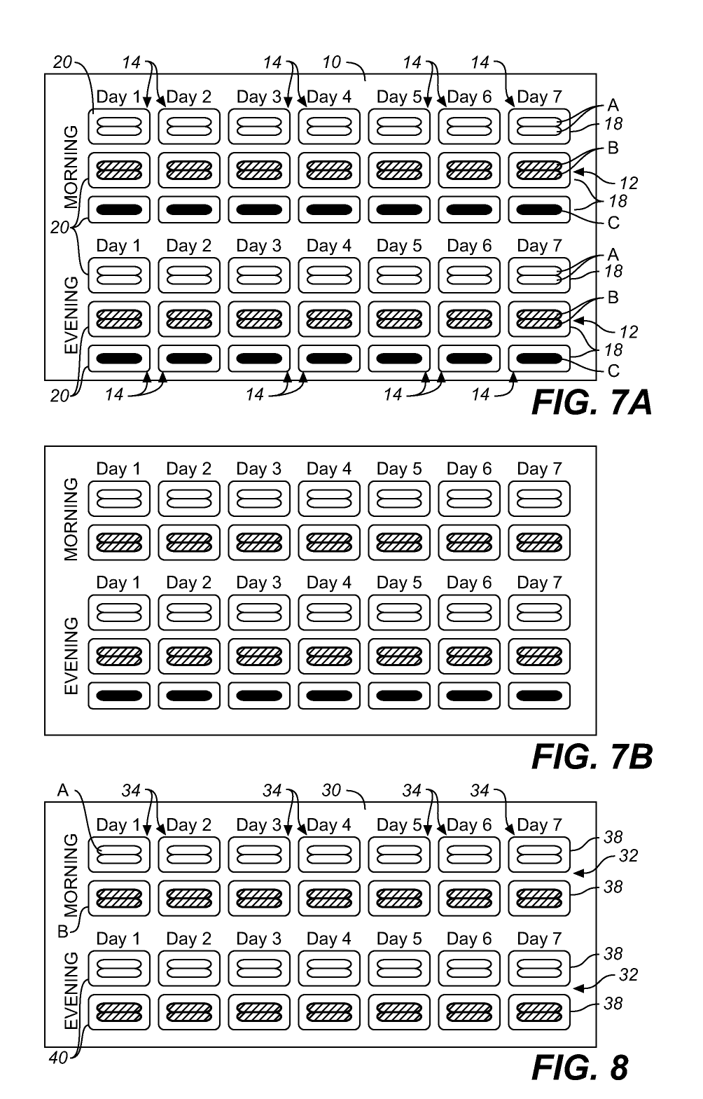

With reference to FIG. 7A, a blister pack (10) according to the present invention is arranged to provide a plurality of rows (12), each row (12) comprising a plurality of doses (14). In the present example, there are two such rows (12), each row comprising seven doses, although the number of rows or doses may be varied as convenient.

Each dose comprises a plurality of different kinds of dosage form, which are grouped together by type in separate blisters (20) within each row to form sub-rows (18). A first kind of dosage form (A) contains amantadine, a second kind (B) contains ribavirin, and a third kind (C) contains oseltamivir. The different kinds of dosage forms for a given dose are grouped together in this manner to facilitate adherence to a prescribed dosing regimen. In this example, a single dose comprises two amantadine capsules (A), two ribavirin capsules (B) and one oseltamivir capsule (C), although the number of dosage forms of each kind for each dose may also vary as required. The blister pack shown in FIG. 1A is configured for convenient BID dosing of each of the active agents over a seven day period. The blister pack shown in FIG. 7B is the same as that shown in FIG. 7A except that the oseltamivir is dosed QD.

The amantadine capsules (A) of this example each contain 125 mg amantadine hydrochloride in an extended release form (e.g. as prepared according to U.S. Ser. No. 11/285,905) and are disposed in each of the blisters (20) of the first and fourth sub-rows (18), although each capsule may contain more or less amantadine or a different salt form of amantadine as desired.

The ribavirin capsules (B) of this example each contain 200 mg ribavirin in an immediate release form, e.g., Ribavirin USP Capsules (Schering) and are disposed in each of the blisters (20) of the second and fifth sub-rows (18), although each capsule may contain more or less ribavirin as desired.

The oseltamivir capsules (C) of this example each contain 75 mg oseltamivir, e.g., TAMIFLU™ (Roche Pharmaceuticals) and are disposed in each of the blisters (20) of the third and sixth sub-rows (18), although each capsule may contain more or less oseltamivir as desired.

The blister pack also comprises instructions indicating a typical adult dosage of two amantadine capsules, two ribavirin capsules and one oseltamivir capsule twice per day. It will be appreciated that the blister pack of this example contains dosage forms sufficient for one week of dosing, comprising 28 capsules containing 125 mg amantadine hydrochloride, 28 capsules containing 200 mg ribavirin and 14 capsules containing 75 mg oseltamivir phosphate. Thus, the relative percentage of each active agent per daily dose is 35 wt. % amantadine hydrochloride, 55 wt. % ribavirin and 10 wt. % oseltamivir phosphate.

### EXAMPLE 2

### A Kit of Amantadine Hydrochloride, Ribavirin and Oseltamivir Phosphate

A blister pack similar to the blister pack of Example 1 is configured to provide two rows (12) of three sub-rows (18) of seven blisters (20) per row. Two tablets or capsules of 100 mg amantadine hydrochloride (A) in an immediate release form, e.g., Symmetrel™ (Endo Pharmaceuticals or Novartis) are packaged in each of the blisters (20) of the first and fourth sub-rows (18). Two capsules of 200 mg ribavirin in an immediate release form, e.g., Ribavirin USP Capsules (Schering) are packaged each of the blisters (20) of the second and fifth sub-rows. One capsule of 75 mg oseltamivir, e.g., Tamiflu™ (Roche Pharmaceuticals) is packaged in each of the blisters (20) of the third and sixth sub-rows. The blister pack also comprises instructions indicating a typical adult dosage of two amantadine tablets or capsules, two ribavirin capsules and one oseltamivir capsule twice per day. The blister pack contains dosage forms sufficient for one week of dosing.

### EXAMPLE 3

### A Kit of Extended Release Amantadine Hydrochloride and Ribavirin

With reference to FIG. 8, a different blister pack (30) according to the present invention comprises two rows (32), each of two sub-rows (38) of seven blisters (40) per row to provide two rows of seven doses (34) per row. Each dose (34) comprises two different active agents, amantadine (A) and ribavirin (B), contained in different respective types of dosage form. Each dosage form type for each dose (34) is disposed in a separate blister (40). The amantadine (A) and ribavirin (B) dosage forms for each dose (34) are grouped together to facilitate adherence to the dosing regimen.

In this example, each dose (34) comprises two amantadine capsules (A) and two ribavirin capsules (B). Two capsules (A) of 125 mg amantadine hydrochloride in an extended release form (prepared according to U.S. Ser. No. 11/285,905) are packaged in each of the blisters (40) of the first and third sub-rows (38). Two capsules of 200 mg ribavirin (B) in an immediate release form, e.g., Ribavirin USP Capsules (Schering) are packaged each of the blisters (40) of the second and fourth sub-rows (38).

The blister pack (30) also comprises instructions indicating a typical adult dosage (34) of two amantadine extended release capsules (A) and two ribavirin capsules (B) twice per day (BID). The blister pack contains dosage forms sufficient for one week of dosing. The kit may be used in conjunction with a separately packaged neuraminidase inhibitor such as oseltamivir or zanamivir. Optionally therefore, said instructions may include a further instruction to co-administer one capsule of 75 mg oseltamivir, e.g., Tamiflu™ (Roche Pharmaceuticals) (not shown) once or twice per day in conjunction with the amantadine and ribavirin dosage forms. Optionally, the oseltamivir or zanamivir is provided to the subject separately from the kit as an additionally prescribed medicine.

### EXAMPLE 4

### A Kit of Extended Release Amantadine Hydrochloride, Ribavirin and Oseltamivir

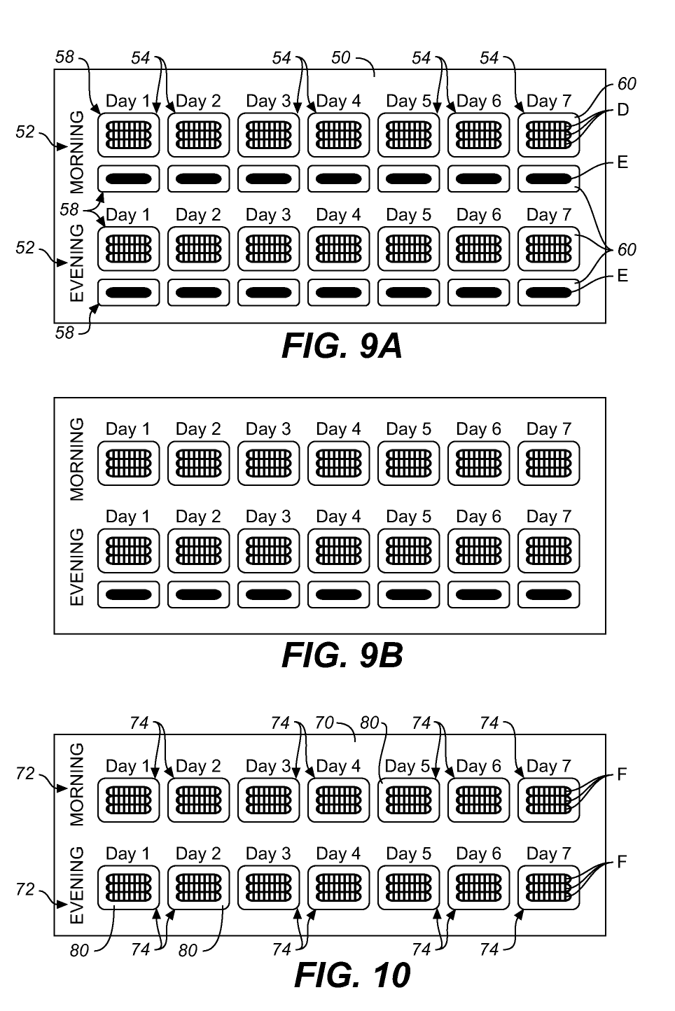

With reference to FIG. 9A, another kit for administering a combination of amantadine chloride, ribavirin and oseltamivir comprises a blister pack (50) which defines two rows (52) of blisters, each row (52) comprising two sub-rows (58) of seven blisters (60) each to define seven doses (54) per row. The rows (52) serve to group together two different types of dosage form (D, E) required for each dose (54). Each dose (54) comprises a plurality of capsules of one type (D) and one capsule of another type (E).

In the present example there are three capsules of the one type (D) per dose, but fewer or more such capsules may be used as required. Said capsules of the one type (D) comprise ribavirin and amantadine hydrochloride, in which the amantadine hydrochloride is provided in an extended release formulation, and the ribavirin is in an immediate release formulation, the two formulations being co-encapsulated.

The capsules of the other type (E) comprise oseltamivir and are grouped with the amantadine ribavirin capsules (D) to facilitate adherence with the prescribing instructions. More than one capsule of the other type (E) per dose (54) may be used if desired. The blister pack (50) of this example is thus configured for BID dosing of the active ingredients over a seven day period. The blister pack shown in FIG. 9B is the same as that shown in FIG. 9A except that the oseltamivir is dosed QD.

### EXAMPLE 5

### A Kit of Extended Release Amantadine Hydrochloride, Ribavirin and Oseltamivir

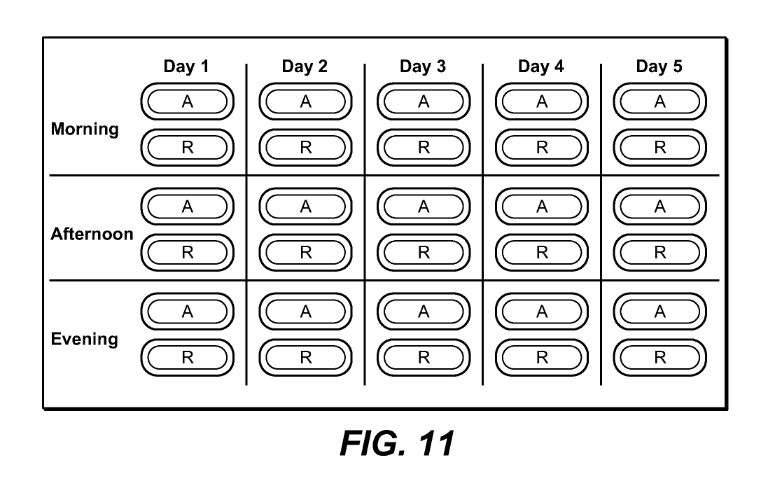

A different blister pack (70) according to the present invention is shown in FIG. 10. Said blister pack (70) defines two rows (72) of blisters (80) in a manner similar to Examples 5-8 above. In this example however, there are no sub-rows, each row comprising a single line of seven blisters (80), each of which blisters accommodates a plurality of dosage forms (F) all of the same type, such that within each blister are sufficient dosage forms (F) to form a single dose (74). Each row (72) thus provides seven doses (74).

Each dosage form (F) in this example comprises amantadine hydrochloride in an extended release form, ribavirin and optionally oseltamivir.

The blister pack (70) is thus configured for BID dosing of each of the active agents over a seven day period. Such a kit could be used alone, especially where the dosage form comprises amantadine, ribavirin and oseltamivir, or in conjunction with a separately packaged neuraminidase inhibitor, e.g., oseltamivir.

### EXAMPLE 6

### A Kit of Amantadine Hydrochloride, Ribavirin and Oseltamivir

Another blister pack according to the present invention is shown in FIG. 11, comprising 15 dosage forms (A) each containing 75 mg amantadine HCl in immediate release form, and 15 dosage forms (R) each comprising 200 mg ribavirin in an immediate release form. Each dosage form is taken three times daily (t.i.d.) for a total daily dose of 225 mg amantadine and 600 mg ribavirin. The blister pack provides a sufficient number of doses for a 5-day course of treatment. Such a kit can be used alone or more preferably in conjunction with a separately packaged neuraminidase inhibitor (e.g. oseltamivir or zanamivir).

### EXAMPLE 7

### A Phase 2 Clinical Trial of the Safety and Efficacy of Intravenous Triple Combination Antiviral Drug Therapy for the Treatment of Severe Avian Influenza

We designed this study to: 1) evaluate the safety and tolerability of i.v. triple combination antiviral drug therapy (TCAD) in the treatment of patients with severe avian influenza; 2) to evaluate the rate and extent of antiviral efficacy of TCAD over the course of treatment as assessed by negative reverse transcriptase-polymerase chain reaction (RT PCR) detection of viral ribonucleic acid (RNA) in upper and lower respiratory tract, gastrointestinal tract (feces), and blood (viremia), nose and throat; and 3) assess the rate and extent of antiviral drug resistance to TCAD over the course of treatment by pyrosequencing (or equivalent).

Study Size: 12 patients

Inclusion Criteria: 1) age≧1 year; 2) fever≧38.0° C.; 3) at least one respiratory symptom: cough, dyspnea (shortness of breath), and/or sore throat; 4) illness (onset of fever, respiratory symptoms, or constitutional symptoms) begun in the last 7 days; and 5) have evidence of epidemiologic risk for avian influenza as defined by meeting one of the following criteria within 14 days prior to the time of illness onset: (a) There were dead or sick birds within the subjects village or neighborhood (within a 2 km radius); (b) The subject had direct bird or poultry contact (either healthy or sick birds or poultry); (c) The subject had face-to-face contact with someone with known or suspected avian influenza; or (d) The subject had possible laboratory exposure to H5N1 virus.

Exclusion Criteria: 1) History of allergy or severe intolerance (as judged by the investigator) to amantadine hydrochloride, zanamivir, and/or ribavirin, and or to any components of these drug products; and 2) Alternate explanation for the patient's clinical symptoms (i.e. other than influenza) as determined by the investigator with the information immediately available.

Screening Criteria: 1) The following samples will be tested by qualitative RT-PCR for H5, however the decision to initiate TCAD therapy is not dependent upon receipt of the results from these tests: nasal swab×2; oropharyngeal (throat) swab×2; nasopharyngeal aspirate (NPA; as the NPA is an obtrusive test for some subjects, the NPA can be omitted or a nasal wash can be substituted for the NPA at the discretion of the investigator); bronchial alveolar lavage (BAL) or endotracheal tube aspirate; blood sample (for viremia, CBC, and serum chemistry); and urine pregnancy for females≧12 years old.

TCAD dosing regimen: The duration of treatment will be a minimum of 5 days, but may be extended as determined by the physician based on the benefit/risk assessment for each individual patient. A kit for 5 days of treatment contains: 1) 10 vials containing ˜4 ml of 100 mg/ml amantadine in water with or without buffer, 2) 10 vials containing 15 ml of 75 mg/ml ribavirin in water with or without buffer, and 3) 10 vials of ˜7 ml of 10 mg/ml zanamivir in water with or without buffer or, as an alternative to zanamivir, 10 vials of lyophilized oseltamivir.

For treatment, 3.3 ml from an amantadine vial is drawn into a syringe and injected into a 500 ml infusion bag of 0.9% or 5% dextrose/0.45% saline producing a concentration of 0.66 mg/ml of amantadine; the infusion volume rate is set to 40 ml/min, which results in an infusion dose rate of 26 mg/hour (630 mg/day). 13.5 ml from a ribavirin vial is drawn into a syringe and injected into a 500 ml infusion bag of saline producing a concentration of 2.03 mg/ml of ribavirin; the infusion volume rate is set to 40 ml/min, which results in an infusion dose rate of 84.6 mg/hour (2030 mg/day). 6.5 ml zanamivir is drawn into a syringe and injected into a 500 ml infusion bag of saline producing a concentration of 0.13 mg/ml of zanamivir; the infusion volume rate is set to 40 ml/min, which results in a infusion dose rate of 5.3 mg/hour (127 mg/day). Alternatively to the zanamivir, 5 ml of water is drawn into a syringe and injected into a vial of lyophilized oseltamivir to reconstitute the sterile powder producing a concentration of 46 mg/ml oseltamivir phosphate; the infusion volume rate is set to 40 ml/min, which results in an infusion dose rate of 18.4 mg/hour (442 mg/day). At these infusion rates new bags of each antiviral agent need to be prepared every 12 hours.

Safety: Adverse events will be monitored. The NIH Division of AIDS Table for Grading the Severity of Adult and Pediatric Adverse Events (DAIDS AE grading table) will be used to assess the severity of an adverse event.

Clinical Evaluations Clinical evaluations include: in-hospital mortality; rate and extent of clinical failure over the course of treatment [clinical failure is defined as death, severe tachypnea (respiratory rate≧30 for ages≧12 years, rate≧40 for ages 6 to 12 years, rate≧45 for ages 3 to 6 years, rate≧50 for ages 1 to 3 years); severe dyspnea (unable to speak full sentences, or use of accessory respiratory muscles); arterial oxygen saturation<92% on room air by trans-cutaneous method; need for mechanical ventilation or ICU admission]; 28-day mortality for subjects; 180-day mortality for subjects; use of mechanical ventilation at any time for subjects; number of ICU admissions for subjects with avian influenza; development of acute respiratory distress syndrome (ARDS) at any time for subjects; duration of hospitalization for subjects; duration of symptoms as defined by time to absence of fever, no or minimal symptoms, no need for relief medication, and resumption of normal activity.

Virologic Endpoints: Virologic evaluations include: rate and extent of viral load and shedding over the course of treatment as assessed by negative RT-PCR for viral RNA in nose and throat swabs, blood, NAL and BAL samples; rate and extent of the emergence of amantadine or zanamivir antiviral drug resistance as determined by pyrosequencing; and genetic characterization of resistant variants.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

1. A method of stockpiling a combination antiviral therapy for responding to an epidemic viral outbreak comprising:
a) procuring a plurality of therapeutic doses of a first antiviral agent having a first mechanism of action;
b) procuring a plurality of therapeutic doses of a second antiviral agent having a second mechanism of action; and
c) coordinating storage of the plurality of therapeutic doses of the first and second antiviral agents to enable shipment of the plurality of therapeutic doses of the first antiviral agent and shipment of the plurality of therapeutic doses of the second antiviral agent within 48 hours of each other.

2. A method of stockpiling a combination antiviral therapy for responding to an epidemic viral outbreak comprising:
a) procuring a plurality of therapeutic doses of a first antiviral agent having a first mechanism of action;
b) procuring a plurality of therapeutic doses of a second antiviral agent having a second mechanism of action; and
c) coordinating storage of the therapeutic doses of the first and second antiviral agents to enable within 48 hours either shipment or co-deployment to a site of epidemic viral outbreak in amounts sufficient to treat at least 100 patients with the combination antiviral therapy.

3. The method of claim 1 or claim 2 comprising:
c) coordinating storage of the therapeutic doses of the first and second antiviral agents to enable co-deployment within 48 hours to a site of epidemic viral outbreak in amounts sufficient to treat at least 100 patients with the combination antiviral therapy.

4. A stockpile of a combination antiviral therapy for responding to an epidemic influenza outbreak comprising:
a) a plurality of doses of a first antiviral agent having a first mechanism of action; and
b) a plurality of doses of a second antiviral agent having a second mechanism of action,
wherein the stockpile is stored to enable rapid deployment of the combination antiviral therapy in amounts sufficient to treat at least 100 patients.

5. The stockpile of claim 4 comprising:
c) a plurality of doses of a third antiviral agent having a third mechanism of action.

6. The stockpile of claim 4 wherein the amounts are sufficient to treat at least 1000, 10,000, 100,000, or 1,000,000 patients.

7. The stockpile of claim 4 wherein the first antiviral agent is for parenteral administration and the stockpile further comprises a plurality of a devices for parenteral administration of the first antiviral agent.

8. The stockpile of claim 4 wherein the first and second antiviral agents are formulated for parenteral administration.

9. The stockpile of claim 5 wherein the first, second, and third antiviral agents are formulated for parenteral administration.

10. The stockpile of claim 4 wherein the first and second antiviral agents are co-formulated in a combination dosage form and the third antiviral agent is in a separate dosage form.

11. The stockpile of claim 4 wherein at least a portion of the treatments of the first and second antiviral agents are stored within a single shipping container.

12. The stockpile of claim 4 wherein the first and second antiviral agents are stored in separate facilities.

13. The stockpile of claim 4 wherein each of the first and second antiviral agents are stored together in multiple facilities.

14. The stockpile of claim 4 wherein the first antiviral agent is amantadine or rimantadine and the second antiviral agent is ribavirin.

15. The stockpile of claim 5 wherein the first antiviral agent is amantadine or rimantadine, the second antiviral agent is ribavirin, and the third antiviral agent is oseltamivir or zanamivir.

16. A method of procuring a plurality of therapeutic doses of a first antiviral agent having a first mechanism of action for use in a stockpile of any one of claims 4 to 13 comprising:
a) procuring a plurality of doses of a first antiviral agent having a first mechanism of action; and
b) coordinating storage of the plurality of therapeutic doses of the first antiviral agent with a plurality of therapeutic doses of a second antiviral agent having a second mechanism of action to enable shipment of the plurality of therapeutic doses of the first antiviral agent and shipment of the plurality of therapeutic doses of the second antiviral agent within 48 hours of each other.

17. A method of procuring a plurality of therapeutic doses of a first antiviral agent having a first mechanism of action for use in a stockpile of any one of claims 4 to 13 comprising:
a) procuring a plurality of doses of a first antiviral agent having a first mechanism of action; and
b) coordinating storage of the therapeutic doses of the first antiviral agent with doses of a second antiviral agent having a second mechanism of action to enable within 48 hours either shipment or co-deployment to a site of epidemic viral outbreak in amounts sufficient to treat at least 100 patients with the combination antiviral therapy.

18. The method of claim 16 or claim 17 comprising:
b) coordinating storage of the therapeutic doses of the first antiviral agent with doses of a second antiviral agent having a second mechanism of action to enable co-deployment within 48 hours to a site of epidemic viral outbreak in amounts sufficient to treat at least 100 patients with the combination antiviral therapy.

19. The method of any one of claims 1 to 3 further comprising procuring a plurality of therapeutic doses of a third antiviral agent having a third mechanism of action and coordinating storage of the third antiviral agent to enable its rapid deployment together with the first and second antiviral agents.

20. The method of claim 16 or claim 17 further comprising coordinating storage of the therapeutic doses of the first antiviral agent with doses of a third antiviral agent having a third mechanism of action to enable its rapid deployment together with the first and second antiviral agents.

21. The method of any one of claims 1 to 3, 16 or 17 wherein the stockpiling is pursuant to an emergency preparedness program.

22. The method of any one of claims 1 to 3, 16 or 17 wherein the first, and optionally second, antiviral agent is formulated for parenteral administration and the method further comprises procuring a plurality of devices for parenteral administration of the first, and optionally second, antiviral agent, and coordinating storage of the devices to enable rapid co-deployment of the devices with the first and second antiviral agents.

23. The method of any one of claims 1 to 3, 16 or 17 wherein the first and second antiviral agents are formulated for parenteral administration.

24. The method of claim 22 or claim 23 wherein the devices are selected from the group consisting of infusion bags, tubing, needles, heparin locks, metering devices, metering pumps, and combinations thereof.

25. The method of claim 19 or claim 20 wherein the first, second, and third antiviral agents are formulated for parenteral administration.

26. The method of claim 19 or claim 20 wherein the first and second antiviral agents are co-formulated in a combination dosage form and the third antiviral agent is in a separate dosage form.

27. The method of any one of claims 1 to 3, 16 or 17 wherein the amounts are sufficient to treat at least 1000, 10,000, or 100,000 patients.

28. The method of any one of claims 1 to 3, 16 or 17 wherein the first and second antiviral agents are stored in a common facility.

29. The method of claim 25 wherein at least a portion of the treatments of the first and second antiviral agents are stored within a single shipping container.

30. The method of any one of claims 1 to 3, 16 or 17 wherein the first and second antiviral agents are stored in separate facilities.

31. The method according to any one of claims 1 to 3, 16 or 17 wherein each of the first and second antiviral agents are stored together in multiple facilities.

32. The method of claim any one of claims 1 to 3, 16 or 17 further comprising:
d) procuring a plurality of prophylactic doses of the first antiviral agent;
e) procuring a plurality of prophylactic doses of the second antiviral agent; and
f) coordinating storage of the prophylactic doses of the first and second antiviral agents to enable their rapid co-deployment together with the therapeutic doses.

33. The method of claim 32 wherein the therapeutic doses of the first antiviral agent is for parenteral administration, and the prophylactic doses of the first antiviral agent are for oral administration.

34. The method of claim 32 wherein the therapeutic doses of the first and second antiviral agents if for parenteral administration, and the prophylactic doses of the first and second antiviral agents are for oral administration.

35. The method of any one of claims 1 to 3, 16 or 17, wherein the epidemic viral outbreak is an influenza epidemic or pandemic.

36. A method of stockpiling a plurality of doses of an M2 inhibitor, an antiviral nucleoside analogue and, optionally, a neuraminidase inhibitor, comprising coordinating a selection of a plurality of doses of an M2 inhibitor, an antiviral nucleoside analogue and, optionally, a neuraminidase inhibitor in an emergency preparedness program for pandemic influenza, and storing the plurality of doses pursuant to the emergency preparedness program.

37. The method of claim 36, further comprising deploying the plurality of doses from storage, optionally with instructions for co-administration of the M2 inhibitor, the antiviral nucleoside analogue and optionally the neuraminidase inhibitor for treatment of the influenza.

38. A method of drug co-deployment comprising:
a) determining whether a facility in which a first drug is stored has a second drug present in the same facility or other location under common inventory control as the facility;
b) obtaining the second drug when a determination is made that: (i) the second drug is not present in the facility or other location; or (ii) the second drug is not present in the facility or other location in a sufficient given quantity to support co-deployment of the first and second drugs; and
c) storing the first and second drugs for co-deployment.

39. The method of claim 38 wherein the first and/or second drug is stored in bulk in combination with high throughput equipment for preparing unit dosage forms.

40. The method of claim 38 wherein the first and/or second drug is stored as a raw material (i.e. active pharmaceutical ingredient).

41. A method of monitoring the suitability of a stockpile of any one of claims 4 to 13 for deployment in an epidemic comprising the steps of:
a) monitoring the suitability of the plurality of doses of the first antiviral agent for deployment in an epidemic;
b) monitoring the suitability of the plurality of doses of the second antiviral agent for deployment in an epidemic; and, if the results from steps a) and b) indicate that the plurality of doses of the first antiviral agent and the plurality doses of the second antiviral agent are suitable for deployment in an epidemic, then
c) approving the stockpile for deployment in an epidemic.

42. A computer program comprising computer-executable instructions, comprising:
first instructions for determining whether a facility in which a first drug is stored has a second drug present in the same facility or other location under common inventory control as the facility; and
second instructions for determining whether: (i) the second drug is not present in the facility or other location; or (ii) the second drug is not present in the facility or other location in a sufficient given quantity to support co-deployment of the first and second drugs.

43. The computer program of claim 42 further comprising third instructions for generating a request for obtaining the second drug when the second instructions make an affirmative determination.

44. A computer program product comprising the computer program of claim 42 or claim 43.

45. A system for monitoring drug co-deployment, comprising:
memory for storing the computer program of claim 42 or claim 43; and
a processor connected to the memory for executing the computer-executable instructions of the computer program

46. The system of claim 45, further comprising:
an accessor in communication with the memory for supplying data relating to quantities of first and second drugs present in the facility.
